(19) United States
(12) Patent Application Publication
(10) Pub. No.: US 2025/0277082 A1
(43) Pub. Date: Sep. 4, 2025

(54) PHOTOCURABLE COMPOSITION

(71) Applicant: Panasonic Intellectual Property Management Co., Ltd., Osaka (JP)

(72) Inventors: HONAMI NAWA, Shiga (JP); KEISUKE KAWASHIMA, Osaka (JP)

(21) Appl. No.: 19/211,347

(22) Filed: May 19, 2025

Related U.S. Application Data
(63) Continuation of application No. PCT/JP2023/033551, filed on Sep. 14, 2023.

(30) Foreign Application Priority Data
Nov. 30, 2022 (JP) 2022-192246

(51) Int. Cl. C08G 59/66

(52) U.S. Cl. CPC C08G 59/66

(57) ABSTRACT

A photocurable composition including at least components (A), (B), (C), and (D): (A) a compound having two or more glycidyl groups per molecule; (B) a compound having a glycoluric acid structure and two or more thiol groups per molecule; (C) at least one photobase generator selected from a group consisting of a biguanide compound having a cyclic group and a carbamate having a cyclic group; and (D) a photosensitizer having an anthraquinone skeleton, wherein the component (C) is included in a proportion of 1 to 10 mass % with respect to a total mass of the components (A), (B), and (C).

### TECHNICAL FIELD

The present disclosure relates to a photocurable composition that is excellent in reactivity and storage stability, and produces a cured product excellent in curability.

### BACKGROUND ART

Photocurable compositions can be generally divided into three types: radical type, cation type, and anion type, depending on components that the initiator generates by photoirradiation. Among them, radical-type photocurable compositions have been widely developed and widely put into practical use because the photocuring rate of monomers, oligomers, or polymers thereof can be improved. However, a radical-type photocurable composition is inhibited from polymerization reaction due to oxygen in the air and suppressed in curing, which necessitates a special measure for blocking oxygen.

On the other hand, a cation-type photocurable composition is not inhibited from polymerization reaction due to oxygen as a radical-type photocurable composition. However, strong acids generated from the photoacid generator remain in the resin even after curing, which leads to a risk of corrosion and yellowing of the resin caused by the presence of the strong acids.

From such a background, as a new photocurable composition that is free from oxygen inhibition as in a radical-type photocurable composition, is free from corrosion and yellowing by acids as in a cation-type photocurable composition, and is more excellent in reactivity, an anion-type photocurable composition that generates a base by the action of light and uses the base as a catalyst has attracted attention.

While attracting attention as above, anion-type photocurable compositions are required not only to provide a high performance and small-sized package for electronic components supporting the high-speed communication technology, but also to have long-term durability and heat resistance under a high-temperature environment. Furthermore, also in the manufacturing process of a component, it is required that the curing process is performed in lower temperatures in order to suppress the occurrence of peeling and cracking due to thermal strain at the adhesion interface between resin and metal or between resin and ceramic to reduce damage to the component.

### CITATION LIST

### Patent Literature

PTL 1: International Publication No. WO 2013/089100

PTL 2: Unexamined Japanese Patent Publication No. 2009-167252

### SUMMARY OF THE INVENTION

In an embodiment of the present disclosure, a photocurable composition includes at least components (A), (B), (C), and (D):
(A) a compound having two or more glycidyl groups per molecule;
(B) a compound having a glycoluric acid structure and two or more thiol groups per molecule;
(C) at least one photobase generator selected from a biguanide compound having a cyclic group and a carbamate having a cyclic group; and
(D) a photosensitizer having an anthraquinone skeleton, wherein the component (C) is included in a proportion of 1 to 10 mass % with respect to a total mass of the components (A), (B), and (C).

### DESCRIPTION OF EMBODIMENT

For example, when an epoxy resin composition (one kind of anion-type photocurable compositions) conventionally used for electronic material use is cured to form a sealing body, or to form an insulating coating layer on the surface of an element in a component, the epoxy resin composition needs to be heated and cured at relatively high temperatures (for example, 120° C. or higher) in order to improve the heat resistance of the epoxy resin. Such an epoxy resin composition that produces a cured product excellent in heat resistance is difficult to achieve both excellent low-temperature curability (reactivity) and excellent storage stability.

For example, PTL 1 discloses that an epoxy resin is cured by a compound that generates a highly basic amidine by light as a photoanion initiator as a photobase initiator, and an epoxy resin and a thiol compound are included in a composition. However, when the epoxy resin and the thiol described in PTL 1 are used, curability at 90° C. and storage stability are excellent, but heat resistance as a cured product is not sufficient.

PTL 2 discloses an epoxy resin composition for a sealant containing an epoxy resin (A) having an epoxy group, an organic compound (B) having a mercapto group, and a benzoxazine compound (C). The composition contains a thiol compound as the organic compound (B), thereby imparting room temperature curability to the composition. The composition contains the benzoxazine compound (C) that increases the glass transition temperature of the cured product, thereby providing the cured product of the composition with heat resistance (specifically, a glass transition temperature of 140 to 150° C.). However, the composition starts curing at room temperature (for example, 25° C.), and is poor in storage stability. As described above, an epoxy resin composition that produces a cured product having heat resistance is insufficient in achieving both excellent low-temperature curability and excellent storage stability.

The present disclosure has been made to solve the above-described conventional problems, and an object thereof is to provide a photocurable resin composition excellent in low-temperature curability (reactivity), storage stability, and heat resistance.

Hereinafter, exemplary embodiments of the present disclosure will be specifically described. The present disclosure is not limited to these exemplary embodiments. The present disclosure can be appropriately modified and implemented within the scope of the object of the present disclosure.

A numerical range referred to herein is intended to also include the lower limit and the upper limit themselves, unless otherwise noted, such as “less than”, “greater than”, and “smaller than”. For example, a numerical range of 1 to 10 wt % is interpreted that the numerical range includes the lower limit “1 wt %” and the upper limit “10 wt %”.

Hereinafter, the photocurable composition of an exemplary embodiment of the present disclosure (hereinafter, referred to as “the exemplary embodiment”) will be described in detail.

### Photocurable Composition

In an exemplary embodiment of the present disclosure (hereinafter, referred to as “the exemplary embodiment”), the photocurable composition includes:
(A) a compound having two or more glycidyl groups per molecule;
(B) a compound having a glycoluric acid structure and two or more thiol groups per molecule;
(C) at least one photobase generator selected from a group consisting of a biguanide compound having a cyclic group and a carbamate having a cyclic group; and
(D) a photosensitizer having an anthraquinone skeleton.

The photocurable composition of the exemplary embodiment may be blended with other components such as various additives, in addition to the components (A), (B), (C), and (D), as long as the main effect of the present disclosure (“low-temperature curability (reactivity)” and “excellent storage stability” of the photocurable composition, and “excellent heat resistance” of the cured product thereof) is not impaired. Examples of the additive include a reactive diluent and the like.

The active energy ray is, for example, an ultra-violet light (UV), an electron beam, an α-ray, and a β-ray, and is specifically an ultra-violet light.

Irradiation with an active energy ray is not particularly limited, but can be performed, for example, at a temperature of 20° C. or higher and 30° C. or less.

Hereinafter, each component (components (A), (B), (C), and (D), and other components) will be described in detail.

### [Component (A)]

The component (A) is a compound having two or more glycidyl groups (C₂H₃O)—CH₂— in one molecule (hereinafter, also referred to as “glycidyl group-containing compound”). The glycidyl group-containing compound as the component (A) forms the main skeleton of a cured product formed by anionic polymerization of the photocurable composition of the exemplary embodiment.

The glycidyl group-containing compound as the component (A) includes not only a compound called a monomer but also a prepolymer (for example, a compound having a weight average molecular weight of less than 10,000) and a polymer (for example, a compound having a weight average molecular weight of 10,000 or more), each of which is obtained by polymerizing two or more monomers.

The glycidyl group-containing compound as the component (A) may further have a functional group other than a glycidyl group in addition to a glycidyl group. Specific examples of such a functional group include an epoxy group, a hydroxyl group, an acrylic group, a methacrylic group, a vinyl group, an acetal group, an ester group, a carbonyl group, an amide group, and an alkoxysilyl group. The glycidyl group-containing compound may have each of these functional groups alone, or may have two or more kinds thereof in mixture.

Specific examples of the component (A) include, but are not limited to, an epi-bis type liquid epoxy resin, alcohol diglycidyl ether, and derivatives thereof.

The epi-bis type liquid epoxy resin is a bisphenol diglycidyl ether (a compound having a bisphenol skeleton and having two or more glycidyl ether groups). Examples thereof include bisphenol A diglycidyl ether (a compound having a bisphenol A skeleton and having two glycidyl ether groups: a diglycidyl ether derived from bisphenol A and epichlorohydrin); and bisphenol F diglycidyl ether (a compound having a bisphenol F skeleton and having two glycidyl ether groups: a diglycidyl ether derived from bisphenol F and epichlorohydrin).

Examples of the alcohol diglycidyl ether include an aliphatic alcohol diglycidyl ether and an aromatic alcohol diglycidyl ether.

Examples of the derivative of the epi-bis type liquid epoxy resin include a derivative of bisphenol A glycidyl ether. Examples of the derivative of bisphenol A glycidyl ether include hydrogenated bisphenol A glycidyl ether (a glycidyl ether derived from hydrogenated bisphenol A and epichlorohydrin), and α,α,α′-tris(4-hydroxyphenyl)-1-ethyl-4-isopropylbenzene diglycidyl ether (a compound having α,α,α′-tris(4-hydroxyphenyl)-1-ethyl-4-isopropylbenzene as a skeleton and having a glycidyl ether group).

Among them, the glycidyl group-containing compound as the component (A) is preferably bisphenol A diglycidyl ether and α,α,α′-tris(4-hydroxyphenyl)-1-ethyl-4-isopropylbenzene triglycidyl ether from the viewpoint of having curability, adhesiveness of a cured product, and high physical strength in a well-balanced manner.

The glycidyl group-containing compound as the component (A) is preferably a glycidyl group-containing compound having three or more glycidyl ether groups from the viewpoint of improving the heat resistance of the cured product of the photocurable composition.

The glycidyl group-containing compound as the component (A) is preferably a glycidyl group-containing compound that has an aliphatic hydrocarbon, a cycloaliphatic hydrocarbon (aliphatic ring), and an aromatic hydrocarbon (aromatic ring) in the skeleton (that is, a glycidyl group-containing compound having at least one ring selected from the group consisting of an aromatic ring and an aliphatic ring in the skeleton) from the viewpoint of improving the transparency, weather resistance, and flexibility of the photocurable composition. Here, examples of the aromatic ring include a monocyclic aromatic ring (more specifically, a benzene ring) and a polycyclic aromatic ring (a fused ring of two or more aromatic rings: more specifically, a naphthalene ring, an anthracene ring, a phenalene ring, and the like). These rings may further be fused with an aliphatic ring. Examples of the aliphatic ring include a monocyclic aliphatic ring (more specifically, a cyclopentane ring, a cyclohexane ring, a cycloheptane ring, and the like) and a fused ring (more specifically, a bicycloundecane ring or the like). Examples of the glycidyl group-containing compound that has an aromatic hydrocarbon in the skeleton include a bisphenol diglycidyl ether (more specifically, α,α,α′-tris(4-hydroxyphenyl)-1-ethyl-4-isopropylbenzene triglycidyl ether, “BATG manufactured by Showa Denko K. K. described later, and the like).

Examples of a commercially available epoxy resin product include, but are not limited to, JER (old EPIKOTE) 828, 1001, 801, 806, 807, 152, 604, 630, 871, YX8000, YX8034, and YX4000, each of which is manufactured by Mitsubishi Chemical Corporation, DENACOL EX614B, EX411, EX314, EX201, EX212, and EX252, each of which is manufactured by Nagase ChemteX Corporation, TEPIC, TEPIC-S, and TEPIC-VL, each of which is manufactured by Nissan Chemical Corporation, BATG, which is manufactured by Showa Denko K.K., and VG3101L, which is manufactured by Printec Corporation. These commercially available epoxy resin products may be used singly or in combination of two or more kinds thereof.

The content of the component (A) is, for example, 45 to 65 parts by mass with respect to 100 parts by mass of the total mass of the components (A), (B), and (C) contained in the photocurable composition of the exemplary embodiment.

### [Component (B)]

The component (B) is a compound having a glycoluric acid structure and having two or more thiol groups in one molecule (hereinafter, also referred to as “thiol group-containing gly coluril derivative”). In the present specification, the “glycoluric acid structure” refers to a fused heterocyclic structure in which a glycoluril (or also referred to as acetylene urea or tetrahydroimidazo [4,5-d]imidazole-2,5(1H,3H)-dione; C₄H₆N₄O₂) loses hydrogen atoms each bonded to the four nitrogen atoms. The thiol group-containing glycoluril derivative is a compound in which a glycoluril has at least two of the hydrogen atoms each bonded to the four nitrogen atoms substituted with a functional group having a thiol group.

The thiol group-containing glycoluril derivative as the component (B) acts as a crosslinking agent in the photocurable composition of the exemplary embodiment. Specifically, when the photocurable composition of the exemplary embodiment is irradiated with light, the component (C) is decomposed to produce a base. The generated base abstracts a proton (H⁺) from the thiol group of the component (B) to generate a thiolate anion of the component (B). The generated thiolate anion reacts with the glycidyl group of the glycidyl group-containing compound of the component (A) to form a covalent bond. Presumably, crosslinking is formed in this way.

Examples of the thiol group-containing glycoluril derivative as the component (B) include a compound represented by the following general formula (1):

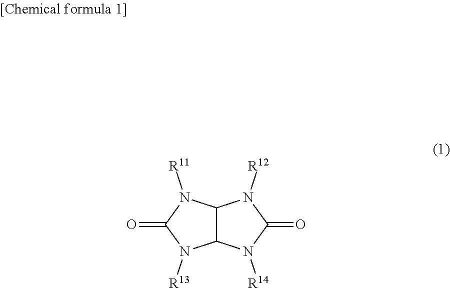

wherein, in the general formula (1),
at least two of R¹¹, R¹², R¹³, and R¹⁴ include a thiol group;
R¹¹, R¹², R¹³, and R¹⁴ each independently represent a hydrogen atom, an alkanethiol group, or a sulfide group; and
R¹¹, R¹², R¹³, and R¹⁴ may be identical to each other, or may be different from each other.

In the general formula (1), the alkanethiol group is, for example, an alkanethiol group having 1 to 5 carbon atoms, and can be represented by CₙH₂ₙ₊₁SH (n represents a positive integer of 1 to 5). Examples of the alkanethiol group having 1 to 5 carbon atoms include a methanethiol group, an ethanethiol group, a propanethiol group (more specifically, a n-propanethiol group and an isopropanethiol group), a butanethiol group (more specifically, a n-butanethiol group, an isobutanethiol group, and the like), and a pentanethiol group (more specifically, a n-pentane group, an isopentanethiol group, and the like).

In the general formula (1), the sulfide group is, for example, a sulfide group having 2 to 6 carbon atoms, and can be represented by CₖH₂ₖ₊₁SCₘH₂ₘ₊₃ (k and m each independently represent a positive integer of 1 to 3). Examples of the sulfide group having 2 to 6 carbon atoms include a methylsulfanylmethyl group, a methylsulfanylethyl group, a methylsulfanylpropyl group, an ethylsulfanylmethyl group, an ethylsulfanylethyl group, and an ethylsulfanylpropyl group.

In the general formula (1), R¹¹, R¹², R¹³, and R¹⁴ each independently preferably represent CₙH₂ₙ₊₁SH (n represents a positive integer of 1 to 5), more preferably represent —CₙH₂ₙ₊₁SH (n represents a positive integer of 1 to 3), and still more preferably represent —CₙH₂ₙ₊₁SH (n represents a positive integer of 2 to 3).

In the general formula (1), CₙH₂ₙ₊₁SH (n represents a positive integer of 1 to 5), represented by R¹¹, R¹², R¹³, and R¹⁴, may be linear or branched, but is preferably linear.

In the general formula (1), R¹¹, R¹², R¹³, and R¹⁴ may be identical to each other or different from each other, but are preferably identical to each other.

Preferably, a compound having a glycoluric acid structure as a skeleton and having four thiol groups or a compound having a sulfide group in addition to two or more thiol groups can be used.

Examples of a commercially available thiol product (thiol group-containing glycoluril derivative) include TS-G and C3TS-G, each of which is manufactured by SHIKOKU CHEMICALS CORPORATION. These compounds may be used singly or in combination of two or more kinds thereof.

The content of the component (B) is, for example, 35 to 55 parts by mass with respect to 100 parts by mass of the total mass of the components (A), (B), and (C) contained in the photocurable composition of the exemplary embodiment.

### [Component (C)]

The component (C) is at least one photobase generator selected from a biguanide compound having a cyclic group and a carbamate having a cyclic group.

The photobase generator of the component (C) has a base that is latent to an active energy ray. When the photocurable composition is irradiated with an active energy ray, the photobase generator of the component (C) is decomposed to generate a base. In the anionic polymerization reaction, the generated base promotes a ring-opening polymerization reaction between glycidyl groups of the component (A) (homopolymerization reaction) and promotes an addition polymerization reaction of the component (B) to the component (A). Furthermore, the biguanide compound having a cyclic group and the carbamate having a cyclic group have a relatively bulky cyclic group. Accordingly, active species are less likely to physically approach the portion corresponding to a base latently contained in the biguanide compound and the carbamate. For this reason, the biguanide compound having a cyclic group and the carbamate having a cyclic group hardly proceed a dark reaction. Therefore, the photocurable composition of the exemplary embodiment, containing the component (C), is excellent in storage stability.

(Biguanide Compound having Cyclic Group)

The biguanide compound having a cyclic group herein refers to a compound having a biguanide structure (skeleton structure in which a biguanide loses a hydrogen atom: NC(═N)NC(═N)N) and a cyclic group, or a salt thereof. In other words, the biguanide compound having a cyclic group is a compound in which at least one of the seven hydrogen atoms of a biguanide (or diguanide: H₂NC(═NH)NHC(═NH)NH₂) is substituted with a cyclic group, or a salt thereof.

The biguanide compound having a cyclic group is represented by a general formula (2):

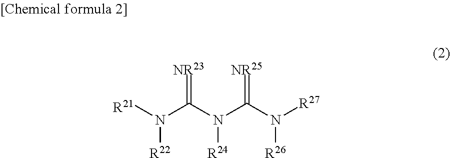

wherein, in the general formula (2),
R²¹, R²², R²³, R²⁴, R²⁵, R²⁶, and R²⁷ each independently represent a hydrogen atom, an alkyl group having 1 to 3 carbon atoms, and a cyclic group; and
at least one of R²¹, R²², R²³, R²⁴, R²⁵, R²⁶, and R²⁷ represents a cyclic group.

In the general formula (2), examples of the alkyl group having 1 to 3 carbon atoms represented by R²¹ to R²⁷ include a methyl group, an ethyl group, a n-propyl group, and an isopropyl group.

In the general formula (2), examples of the cyclic group represented by R²¹ to R²⁷ include an aliphatic cyclic group and an aromatic carbocyclic group, and a non-aromatic heterocyclic group and an aromatic heterocyclic group.

In the general formula (2), examples of the aliphatic cyclic group represented by R²¹ to R²⁷ include a monocyclic cycloalkyl group having 5 to 7 carbon atoms (more specifically, a cycloheptyl group, a cyclohexyl group, and a cycloheptyl group), and a polycyclic group obtained by fusing these groups (fused polycyclic group).

In the general formula (2), the aromatic carbocyclic group represented by R²¹ to R²⁷ is an aromatic ring group in which all ring-member atoms are carbon atoms. Examples thereof include a monocyclic benzene ring group and a polycyclic aromatic ring group (more specifically, a bicyclic naphthalene ring group, a tricyclic anthracene ring group, a tricyclic phenanthrene ring group, and the like).

In the general formula (2), examples of the non-aromatic heterocyclic group represented by R²¹ to R²⁷ include a monocyclic heterocyclic group having 5 to 6 carbon atoms (more specifically, an imidazole group, a tetrahydropyranyl group, a piperidinyl group, a thianyl group, a monophonylinyl group, and the like), a polycyclic group obtained by fusion of these groups, and a polycyclic group obtained by fusion of these groups with the monocyclic aliphatic ring group described above.

In the general formula (2), examples of the aromatic heterocyclic group represented by R²¹ to R²⁷ include a monocyclic aromatic heterocyclic group, a group in which a non-aromatic heterocyclic group is fused to an aromatic carbocyclic group (more specifically, anthraquinone ring group and the like), and a group in which an aliphatic ring group or a non-aromatic heterocyclic group is fused to a monocyclic aromatic heterocyclic group. Examples of the monocyclic aromatic heterocyclic group include a furan ring group, a pyrrole ring group, a thiophene ring group, and a pyridine ring group.

In the general formula (2), the cyclic group represented by R²¹ to R²⁷ may further have a functional group (more specifically, a hydroxyl group, a nitro group, an alkylene group, a carbonyl group, and the like). Examples of the cyclic group further having a functional group include —CR²⁸(OH)C(═O)C₆H₅ (wherein R²⁸ represents an alkyl group having 1 to 3 carbon atoms), and a nitrobenzyl group (more specifically, —CH₂—C₆H₄-o-NO₂ and —CH₂—C₆H₄-p-NO₂).

The salt of the biguanide compound contains a cation of the compound represented by the general formula (2) from which one of R²¹ to R²⁷ is abstracted, and a counter anion. Examples of the counter anion include a borate anion.

Examples of the borate anion include tetraphenylborate and alkyltriphenylborate. The borate anion may have 4 to 20 fluorine atoms per molecule. Examples of the tetraphenylborate include tetrakis (fluorophenyl) borate (more specifically, tetrakis (3-fluorophenyl) borate or the like). Examples of the alkyltriphenylborate include n-butyl triphenylborate.

Examples of the salt of the biguanide compound containing a borate anion as a counter anion include: 1,2-dicyclohexyl-4,4,5,5-tetramethylbiguanidium n-butyltriphenylborate; and (z)-{[bis(dimethylamino)methylidene]amino}-N-cyclohexyl (cyclohexylamino)methanimium=tetrakis(3-fluorophenyl)borate.

Examples of the biguanide compound having a cyclic group include (z)-{[bis (dimethylamino)methylidene]amino}-N-cyclohexyl(cyclohexylamino)methaneiminium =tetrakis(3-fluorophenyl)borate.

(Carbamate having Cyclic Group)

The carbamate having a cyclic group refers herein to a carbamic acid ester having a N—C(═O)O structure. The carbamate has at least one of a cyclic group bonded (directly or indirectly) to the nitrogen atom or the oxygen atom (in the chemical formula, the rightmost oxygen atom) of N—C(═O) O, and a cyclic group whose ring member atoms include the nitrogen atom. The cyclic group that the carbamate has is, for example, the cyclic group that the biguanide compound has.

Examples of the carbamate having a cyclic group include 9-anthrylmethyl N,N-diethylcarbamate and 1-(anthraquinone-2-yl)ethyl imidazole-1-carboxylate.

The compound represented by the general formula (2) can be synthesized using a known method. Since the compound represented by the general formula (2) has a cyclic group, a dark reaction between an epoxy group and a thiol group hardly occurs before light irradiation. Therefore, when the photocurable composition contains the compound represented by the general formula (2) as the component (C), the photocurable composition has excellent storage stability when formed into a paste.

When the component (C) described above is used, a strong base such as a guanidine base can be generated after irradiation with an active energy ray (more specifically, ultraviolet rays), the reaction with an epoxy-based compound or the like proceeds in a chain manner, and excellent reaction efficiency is provided. Accordingly, excellent curability is achieved.

The carbamate having a cyclic group as the component (C) is not as basic as a photobase generator such as a guanidine compound having a cyclic group, but is excellent in solubility in an epoxy-based compound and the like, and is also excellent in storage stability.

More preferably, among the above, the component (C) is 1,2-dicyclohexyl-4,4,5,5-tetramethylbiguanidium n-butyltriphenylborate and (z)-{[bis(dimethylamino) methylidene]amino}-N-cyclohexyl(cyclohexylamino)methaniminium=tetrakis(3-fluorophenyl) borate, each of which generates a strong base and are excellent in reactivity. The component (C) is blended in a proportion of 1 to 10 mass % with respect to the total weight of the components (A), (B), and (C). When the proportion of the component (C) is less than 1 mass %, the reactivity is deteriorated and film formation is not achieved. On the other hand, when the proportion of the component (C) exceeds 10 mass %, the reactivity is good, but the storage stability is deteriorated.

Examples of a commercially available photobase generator include WPBG-300 and 345, each of which is manufactured by FUJIFILM Wako Pure Chemical Corporation. These compounds may be used singly or in combination of two or more kinds thereof.

The content of the component (C) is, for example, 1 to 10 parts by mass with respect to 100 parts by mass of the total mass of the components (A), (B), and (C) contained in the photocurable composition of the exemplary embodiment.

### (Component (D))

The component (D) is a photosensitizer having an anthraquinone skeleton. The photosensitizer of the component (D) absorbs light in the ultraviolet range to sensitize the photobase generator of the component (C).

The photosensitizer of the component (D) may have an alkyl group having 1 to 5 carbon atoms (more specifically, a methyl group, an ethyl group, a n-propyl group, an isopropyl group, an-butyl group, an isobutyl group, a sec-butyl group, a tert-butyl group, a n-pentyl group, an isopentyl group, a neopentyl group, a sec-pentyl group, a tert-pentyl group, and a 1-ethylpropyl group).

The component (D) is preferably, for example, 2-methylanthraquinone, 2-ethylanthraquinone, and 2-amylanthraquinone.

Examples of a commercially available photosensitizer include 2-EAQ and 2-AAQ, each of which is manufactured by Yamamoto Chemicals, Inc., and M0156 and B0816, each of which is manufactured by Tokyo Chemical Industry Co., Ltd. These compounds may be used singly or in combination of two or more kinds thereof.

The content of the component (D) is, for example, 0.5 to 5 parts by mass with respect to 100 parts by mass of the total mass of the components (A), (B), (C), and (D) contained in the photocurable composition of the exemplary embodiment.

### [Other Components]

### (Epoxy-Derived Monomer)

The photocurable composition of the exemplary embodiment may further contain an epoxy monomer. When the photocurable composition of the exemplary embodiment contains an epoxy monomer, the photocurable composition has an improved adhesion strength to a metal adherend. Examples of such an epoxy monomer include phenol (EO)₅ glycidyl ether, N-glycidyl phthalimide, and 2-ethylhexyl glycidyl monomer.

Examples of a commercially available epoxy monomer include EX-731 (2-ethylhexyl glycidyl monomer), which is manufactured by Nagase ChemteX Corporation.

Hereinafter, the present disclosure will be described more specifically with reference to examples. Note that the present disclosure is not limited to the following examples at all.

Table 1 shows conditions such as the components (A) to (D) in examples and comparative examples, and will be described in detail later. These measurement results and determination contents are summarized.

The preparation example of photocurable resin composition 1 is described in Example 1.

### EXAMPLE 1

### [1. Preparation of Photocurable Composition]

### (1-1. Preparation of Components (A), (B), (C), and (D))

As the component (A), a glycidyl group-containing compound having four glycidyl groups in one molecule was prepared (“Shofree (registered trademark) BATG”, manufactured by Showa Denko K. K., epoxy group equivalent: 128) (in Table 1, denoted as (A-1)). As the component (B), a tetrafunctional thiol having a glycoluril skeleton as a main skeleton was prepared (“C3TS-G”, manufactured by SHIKOKU CHEMICALS CORPORATION, thiol group equivalent: 110) (in Table 1, denoted as (B-1)). As the component (C), (z)-{[bis(dimethylamino)methylidene]amino}-N-cyclohexyl (cyclohexylamino)methaneiminium=tetrakis(3-fluorophenyl)borate was prepared (“WPBG-345”, manufactured by FUJIFILM Wako Pure Chemical Corporation) (in Table 1, denoted as (C-1)). As the component (D), 2-amyl anthraquinone was prepared (“2-AAQ”, manufactured by Yamamoto Chemicals, Inc.) (in Table 1, denoted as (D-1)).

### (1-2. Preparation of Photocurable Composition)

A mixture of 5.19 parts by mass of the component (A), 4.44 parts by mass of the component (B), 0.30 parts by mass of the component (C), and 0.06 parts by mass of the component (D) was prepared, and sufficiently kneaded using a planetary kneader to prepare photocurable composition 1 of Example 1. Table 1 shows the formulation of the photocurable composition of Example 1. Specifically, Table 1 shows the type of the components (A), (B), (C), and (D) of the photocurable composition, the blending amount thereof (unit: part by mass), and the like.

### [2. Evaluation Method]

The characteristics were evaluated as follows.

### (2-1. Reactivity of Photocurable Composition (Low-Temperature Curability))

The reactivity of the photocurable composition was evaluated based on how well the coating film was cured under specific curing conditions.

First, the photocurable composition was applied onto a silicone rubber sheet to form a coating film. Subsequently, using an ultraviolet irradiator (“UniJet UV-LED series E075Z 365 nm wavelength type, manufactured by Ushio Inc.), the coating film was irradiated with ultraviolet-visible light having a wavelength of about 365 nm under the conditions of an integrated light amount of 10,000 mJ/cm². Thereafter, the coating film was subjected to heat treatment under the conditions of a heating temperature of 100° C. and a heating time of 10 minutes. In this way, a measurement sample (sample for reactivity evaluation) was prepared. Further, a blank was prepared in the same manner as in the measurement sample except that heat treatment was not performed.

Next, the cured product (coating film) was placed in a differential scanning calorimeter (“DSC7000X”, manufactured by Hitachi High-Tech Science Corporation), and the reaction heat was measured under measurement conditions of a measurement temperature of 20 to 350° C. and a temperature raising rate of 20° C./min. In addition, the reaction heat of the blank was measured. From the obtained reaction heat of photocurable composition 1 (measurement object) and the reaction heat of the blank, the reaction rate (unit: %) was calculated using equation (1).

$$\begin{matrix}[ Mathematical formula 1 ] & \\ Reaction rate = ( ( Reaction heat of blank of measurement object ) - ( Reaction heat of measurement object ) ) / ( Reaction heat of blank of measurement object ) \times 100 & ( 1 )\end{matrix}$$

The reactivity of photocurable composition 1 was evaluated from the calculated reaction rate based on the following evaluation criteria. The evaluation results of the reactivity are summarized in Table 1.

### (Evaluation Criteria for Reactivity)

Y (good): The reaction rate is 80% or more.

N (bad): The reaction rate is less than 80%.

(2-2. Storage stability of photocurable composition)

Three grams of the photocurable composition was sealed and stored in a light-shielding container at an indoor temperature of 25° C. Based on the time after sealing, the time (days) until the photocurable composition gelated and stopped flowing was visually measured. Here, the state in which the photocurable composition gelated and stopped flowing was evaluated as a state in which it takes one second or longer after the container is inclined by 90° and before the surface of the photocurable composition becomes parallel to the horizontal plane. The evaluation results of the storage stability are summarized in Table 1. In Table 1, the notation “>14 days” in “Time to gelation (day)” indicates a result that gelation did not occur for 14 days or more.

### (Evaluation Criteria for Storage Stability)

Y (good): The photocurable composition sealed and stored in a light-shielding container does not gelate for 14 days or more.

N (bad): The photocurable composition sealed and stored in a light-shielding container gelates in less than 14 days.

### (2-3. Heat Resistance of Cured Product of Photocurable Composition)

The glass transition temperature of the cured product of the photocurable composition was measured, and the heat resistance of the cured product was evaluated.

First, a measurement sample was prepared. The measurement sample (sample for heat resistance evaluation) was prepared in the same manner as in (2-2. Reactivity of photocurable composition) except that the heat treatment conditions were changed from the heating temperature of 100° C. and the heating time of 10 minutes to the heating temperature of 100° C. and the heating time of 10 minutes and the heating temperature of 150° C. and the heating time of 30 minutes.

The glass transition temperature of the measurement sample (cured product of photocurable composition 1) was measured using a dynamic viscoelasticity measuring apparatus (“DMA7100”, manufactured by Hitachi High-Tech Science Corporation). The measurement conditions were a temperature raising rate of 10° C./min and an application frequency of 10 Hz. As a result of the measurement, the temperature of the peak top of the obtained loss rigidity modulus (G″) was defined as the glass transition temperature. The heat resistance of the cured product of the photocurable composition was evaluated from the obtained glass transition temperature based on the following evaluation criteria. The evaluation results are summarized in Table 1.

### (Evaluation Criteria for Heat Resistance)

Y (good): The cured product of the photocurable composition has a glass transition temperature of 120° C. or higher.

N (bad): The cured product of the photocurable composition has a glass transition temperature of less than 120° C.

### (Overall Evaluation)

The overall evaluation of the photocurable composition was based on the following evaluation criteria from the evaluation results of reactivity, storage stability, and heat resistance. The results of the overall evaluation are summarized in Table 1.

### (Evaluation Criteria for Overall Evaluation)

Y (good): The evaluation results of reactivity, storage stability, and heat resistance are all Y (good).

N (bad): At least one of evaluation results of reactivity, storage stability, and heat resistance is N (bad).

### EXAMPLES 2 to 4 AND COMPARATIVE EXAMPLES 1 to 4

Furthermore, the following reagents were prepared.

### Component (A):

a glycidyl group-containing compound having three glycidyl groups in one molecule (“VG 3101 L”, manufactured by Printec Corporation, 210 eq., denoted as (A-2) in Table 1);

### Component (B):

a tetrafunctional thiol having a glycoluril skeleton as a main skeleton (“TS-G”, manufactured by SHIKOKU CHEMICALS CORPORATION, thiol group equivalent: 96) (in Table 1, denoted as (B-2)); and
a tetrafunctional thiol having a pentaerythritol skeleton as a main skeleton (“Karenz MT (registered trademark) PE1”, available from Showa Denko K.K. (pentaerythritol tetrakis (3-mercaptobutyrate)), 136 eq.) (in Table 1, denoted as (B-3));

### Component (C):

an o-nitrobenzyl photobase generator represented by the following chemical formula:

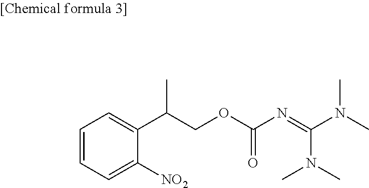 [SMILES: CC(COC(=O)N=C(N(C)C)N(C)C)c1ccccc1[N+](=O)[O-]]

(in Table 1, denoted as (C-2));

### Component (D):

2-propylthioxanthone (“10678”, manufactured by Tokyo Chemical Industry Co., Ltd.) (in Table 1, denoted as (D-2));
   Component (E): a reactive diluent
an epoxy monomer (“EX-731”, manufactured by Nagase ChemteX Corporation, 216 eq., (N-glycidyl phthalimide))

Subsequently, in Examples 2 to 4 and Comparative Examples 1 to 4, photocurable compositions were each prepared in the same manner as in Example 1 except that the formulation was changed as shown in Table 1. In addition, the reactivity and storage stability of the photocurable composition, and the heat resistance of the cured product thereof were evaluated in the same manner as in Example 1. Evaluation results are shown in Table 1.

TABLE 1

| | | Example | | | | Comparative Example | | | |
|---|---|---|---|---|---|---|---|---|---|
| Formulation | Specific compound | 1 | 2 | 3 | 4 | 1 | 2 | 3 | 4 |
| (A) component: | (A-1) | 5.19 | 4.57 | 5.40 | 5.14 | 4.70 | 5.28 | 5.19 | 5.19 |
| Glycidyl group- | | | | | | | | | |
| containing compound | (A-2) | — | 0.81 | — | — | — | — | — | — |
| (B) component: | (B-1) | 4.44 | 4.26 | 1.35 | 4.31 | — | 4.52 | 4.44 | 4.44 |
| Thiol group- | | | | | | | | | |
| containing glycoluril | (B-2) | — | — | 2.70 | — | — | — | — | — |
| derivative | (B-3) | — | — | — | — | 4.97 | — | — | — |
| (C) component: | (C-1) | 0.30 | 0.30 | 0.44 | 0.29 | 0.27 | — | 0.05 | 0.30 |
| Photobase generator | (C-2) | — | — | — | — | — | 0.20 | — | — |
| (D) component: | (D-1) | 0.06 | 0.06 | 0.44 | 0.06 | 0.05 | — | 0.01 | — |
| Photosensitizer | (D-2) | — | — | — | — | — | — | — | 0.06 |
| (E) component: | (E-1) | — | — | — | 0.20 | — | — | — | — |
| Reactive diluent | | | | | | | | | |
| Total (part by mass) | | 10.00 | 10.00 | 10.33 | 10.00 | 10.00 | 10.00 | 9.70 | 10.00 |
| Proportion of component (C) with respect to | | 3.11 | 3.11 | 4.66 | 3.07 | 2.81 | 2.08 | 0.52 | 3.11 |
| total weight of components (A) to (C) (mass %) | | | | | | | | | |
| Evaluation | | | | | | | | | |
| Reactivity | Reaction rate (%) | 98 | 95 | 85 | 98 | 99 | 82 | 50 | 42 |
| | Determination (—) | Y | Y | Y | Y | Y | Y | N | N |
| Storage stability | Time to gelation (day) | >14 | >14 | >14 | >14 | >14 | 3 | >14 | >14 |
| | | days | days | days | days | days | days | days | days |
| | Determination (—) | Y | Y | Y | Y | Y | N | Y | Y |
| Heat resistance | Glass transition | 135 | 123 | 140 | 129 | 67 | 115 | 53 | 90 |
| | temperature (° C.) | | | | | | | | |
| | Determination (—) | Y | Y | Y | Y | N | N | N | N |

| | | | | | | | | |
|---|---|---|---|---|---|---|---|---|
| Overall evaluation: determination (—) | Y | Y | Y | Y | N | N | N | N |

### EXAMPLES 1 to 4

### (Examples 1 to 4)

As shown in Table 1, in Examples 1 to 4, the photocurable composition contained the components (A), (B), (C), and (D), and the proportion of the component (C) was 1 to 10 mass % with respect to the total mass of the components (A), (B), and (C). That is, the photocurable composition of Examples 1 to 4 was a photocurable composition included in the scope of the invention according to claim 1.

As shown in Table 1, in Examples 1 to 4, the results of the overall evaluation were all Y (good).

### COMPARATIVE EXAMPLES 1 to 4

As shown in Table 1, the photocurable composition of Comparative Examples 1 to 4 was a photocurable composition outside the scope of the invention according to claim 1, and the results of the overall evaluation were all N (bad).

### (Comparative Example 1)

Specifically, in the photocurable composition of Comparative Example 1, (B-3) contained as the component (B) was a compound having a pentaerythritol skeleton instead of a glycoluric acid structure in one molecule, and thus was a compound outside the scope of the component (B).

In Comparative Example 1, the heat resistance was evaluated as N (bad). This evaluation result is presumably because (B-3) contained as the component (B) did not have a glycoluric acid structure in one molecule, so that a decreased crosslinking density was obtained through the reaction of epoxy and thiol, and as a result, the glass transition temperature of the cured product could not be sufficiently increased.

### (Comparative Example 2)

The photocurable composition of Comparative Example 2 did not contain the component (D). The (C-2) contained as the component (C) was an o-nitrobenzyl photobase generator, and was neither a biguanide compound having a cyclic group nor a carbamate having a cyclic group.

In Comparative Example 2, the storage stability was evaluated as N (bad). This is presumably because the compound of the component (C) had a guanidine but did not have a cyclohexyl group or a tetrahydropyranyl group, and thus the component (C) functioned as a reaction accelerator in an environment at 25° C. (specifically, the component (C) generated a base even in an environment of 25° C.), so that an addition polymerization reaction between the component (A) and the component (B) (a crosslinking reaction of the component (A) by the component (B)) proceeded.

### (Comparative Example 3)

In the photocurable composition of Comparative Example 3, the proportion of the component (C) was 0.52 mass %, and was not in the range of 1 to 10 mass % with respect to the total mass of the components (A), (B), and (C).

In Comparative Example 3, the reactivity was evaluated as N (bad). This is presumably because the proportion of the component (C) was very small, so that the amount of the generated base was reduced, and as a result, the homopolymerization reaction and the addition polymerization reaction of the glycidyl group-containing compound of the component (A) did not proceed well.

In Comparative Example 3, the heat resistance was evaluated as N (bad). This is presumably because the addition polymerization reaction and the homopolymerization reaction did not proceed well, so that a cured product having a high crosslinking density could not be sufficiently formed.

### (Comparative Example 4)

In the photocurable composition of Comparative Example 4, the compound of the component (D) was 2-propylthioxanthone, and had no anthracene skeleton.

In Comparative Example 4, the reactivity was evaluated as N (bad). This is presumably because the compound of the component (D) did not have an anthraquinone skeleton, and thus could not sufficiently sensitize the component (C) by irradiating light at a wavelength of 365 nm, and as a result, the amount of the generated base decreased, and the homopolymerization reaction and the addition polymerization reaction did not proceed well.

In Comparative Example 4, the heat resistance was evaluated as N (bad). This is presumably because the addition polymerization reaction and the homopolymerization reaction did not proceed well, so that a cured product having a high crosslinking density could not be sufficiently formed.

From the above, Examples 1 to 4, each of which is included in the scope of the present disclosure (the invention according to claim 1), are superior in reactivity, storage stability, and heat resistance to Comparative Examples 1 to 4, each of which is not included in the scope of the present disclosure. Therefore, the photocurable composition of the present disclosure has excellent reactivity, storage stability, and heat resistance.

The present disclosure provides a photocurable resin composition excellent in low-temperature curability (reactivity), storage stability, and heat resistance.

### INDUSTRIAL APPLICABILITY

The photocurable composition of the present disclosure is cured at 100° C. or less by ultraviolet irradiation, and thus can be used, for example, as an adhesive between substrates having low heat resistance such as resin substrates. In addition, the cured product thereof is less likely to corrode metal, and therefore, can be used as an adhesive or coating material for a member having a metal wiring or an electrode, for example.

1. A photocurable composition comprising at least components (A), (B), (C), and (D):
(A) a compound having two or more glycidyl groups per molecule;
(B) a compound having a glycoluric acid structure and two or more thiol groups per molecule;
(C) at least one photobase generator selected from a group consisting of a biguanide compound having a cyclic group and a carbamate having a cyclic group; and
(D) a photosensitizer having an anthraquinone skeleton, wherein
the component (C) is included in a proportion of 1 to 10 mass % with respect to a total mass of the components (A), (B), and (C).

2. The photocurable composition according to claim 1, wherein the compound of the component (A) has a skeleton having at least one ring selected from a group consisting of an aromatic ring and an aliphatic ring.

3. The photocurable composition according to claim 1, wherein the compound of the component (B) includes a compound represented by a general formula (1): 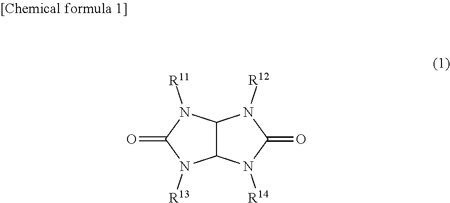
wherein, in the general formula (1),
at least two of R¹¹, R¹², R¹³, and R¹⁴ include a thiol group;
R¹¹, R¹², R¹³, and R¹⁴ each independently represent a hydrogen atom, an alkanethiol group, or a sulfide group; and
R¹¹, R¹², R¹³, and R¹⁴ may be identical to each other, or may be different from each other.
